(19) United States
(12) Patent Application Publication
(10) Pub. No.: US 2025/0352937 A1
(43) Pub. Date: Nov. 20, 2025

(54) INDEPENDENT ADSORPTION AND DESORPTION SYSTEM

(71) Applicant: Mosaic Materials, Inc., Alameda, CA (US)

(72) Inventors: Paul Cody, Houston, TX (US); Samuel Cheng, Katy, TX (US); Dustin Kraft, Houston, TX (US); Steven Craig Russell, The Woodlands, TX (US)

(21) Appl. No.: 18/667,011

(22) Filed: May 17, 2024

(51) Int. Cl. B01D 53/04

(52) U.S. Cl. CPC B01D 53/0454; B01D 53/0438; B01D 2253/30; B01D 2257/504; B01D 2258/06; B01D 2259/40011

(57) ABSTRACT

The invention discloses an automatic replacement device and an automatic replacement method for a dry-type filter module. The automatic replacement device comprises a guide rail, a moving trolley and an unpowered slide rail, the guide rails are distributed in the length direction of the dry-type paint mist intercepting area, a moving trolley is arranged on the guide rails, the moving trolley can move along the guide rails and carry the dry-type filtering module, and the unpowered sliding rail is arranged on the side of the guide rails and extends to the dry-type paint mist intercepting area. The dry-type filtering module disclosed by the invention can be automatically moved in and out through power control, and manual operation is not needed; the moved-out dry type filtering module is automatically conveyed to a hazardous waste area through a moving trolley and a guide rail; when the dangerous waste carrying trolley drives the removed dry type filtering module away from the dry type filtering module to be replaced and automatically conveys the dry type filtering module to a to-be-replaced area, the dry type filtering module is automatically conveyed to the joint of the spraying room paint mist filtering treatment chamber through the power mechanism, the chamber door is automatically closed, the internal seal is opened, and normal filtering operation work is recovered.

### BACKGROUND

Various manufacturing and chemical systems include the use of sorbents to remove gas(es), vapor(s), or a mixture thereof from a fluid via adsorption. For example, adsorption systems such as carbon capture systems may capture carbon dioxide via adsorption with sorbent(s). The sorbents may then be fed to a desorption system to remove the gas(es), vapor(s), or the mixture thereof from the sorbent. Improvement(s) in the adsorption and desorption systems may be desirable.

### SUMMARY

An embodiment of a system comprising a sorbent structure comprising sorbent, an adsorption station comprising an adsorption chamber configured to receive the sorbent structure and configured to have an input gas pass therethrough to adsorb gas(es), vapor(s), or a mixture thereof via the sorbent, a desorption station comprising a desorption chamber configured to receive the sorbent structure and configured to desorb the gas(es), the vapor(s), or the mixture thereof, and a transport system configured to move the sorbent structure to the adsorption station and insert the sorbent structure into, or couple of the sorbent structure to, the adsorption chamber, and configured to move the sorbent structure to the desorption station and insert the sorbent structure into, or couple the sorbent structure to, the desorption chamber, wherein the sorbent structure separates from the transport system upon inserting the sorbent structure into, or coupling the sorbent structure to, the adsorption chamber or the desorption chamber.

An embodiment of a method comprising moving, via a transport system, a sorbent structure comprising sorbent to an adsorption station and separating the sorbent structure from the transport system, performing adsorption for a first period of time on an input gas via the sorbent of the sorbent structure to adsorb gas(es), vapor(s), or a mixture thereof from the input gas, receiving the sorbent structure from the adsorption station via the transport system, moving, via the transport system, the sorbent structure to a desorption station and separating the sorbent structure from the transport system, and performing desorption for a second period of time on the sorbent of the sorbent structure to desorb the gas(es), the vapor(s), or the mixture thereof from the sorbent, wherein the first period of time differs from the second period of time.

### BRIEF DESCRIPTION OF THE DRAWINGS

The following descriptions should not be considered limiting in any way. With reference to the accompanying drawings, like elements are numbered alike:

FIG. 1 is a schematic diagram showing a comparative example of an adsorption and desorption system;

FIG. 2 is a schematic diagram showing an adsorption and desorption system according to one or more embodiments;

FIG. 3A1 is a schematic diagram showing a desorption system according to one or more embodiments;

FIG. 3A2 is a schematic diagram showing a desorption system according to one or more embodiments;

FIG. 3A3 is a schematic diagram showing a desorption system according to one or more embodiments;

FIG. 3B is a schematic diagram showing an adsorption system according to one or more embodiments;

FIG. 4 is a perspective view of an adsorption and desorption system according to one or more embodiments;

FIG. 5A is a perspective view of a sorbent structure according to one or more embodiments;

FIG. 5B is a front view of the sorbent structure of FIG. 5A;

FIG. 5C is a side view of the sorbent structure of FIG. 5A;

FIG. 6A is a perspective view of a transport system according to one or more embodiments;

FIG. 6B is a perspective view of a fastener of the transport system of FIG. 6A;

FIG. 7 is a perspective view of a desorption chamber of a desorption system according to one or more embodiments;

FIG. 8 is a perspective view of an adsorption chamber of a desorption system according to one or more embodiments;

FIG. 9 is a schematic diagram showing an adsorption and desorption system according to one or more embodiments;

FIG. 10A is a perspective view of a desorption chamber of a desorption system according to one or more embodiments;

FIG. 10B is a perspective view of a desorption system according to one or more embodiments;

FIG. 11 is a perspective view of an adsorption system according to one or more embodiments; and

FIG. 12 is a schematic view of a cone and pin guide assembly according to one or more embodiments

### DETAILED DESCRIPTION

A detailed description of one or more embodiments of the disclosed apparatus and method are presented herein by way of exemplification and not limitation with reference to the Figures.

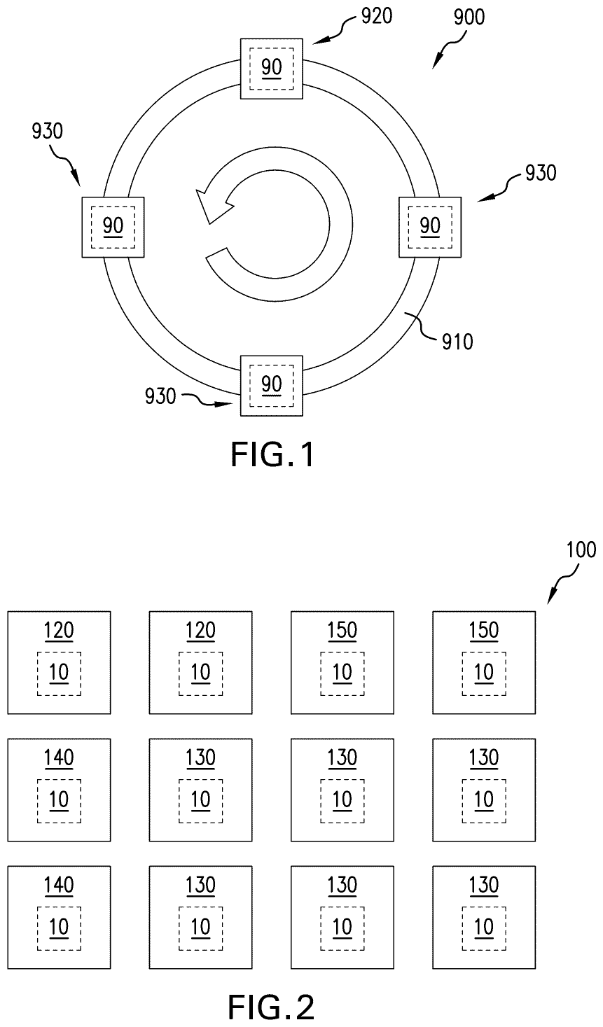

FIG. 1 shows a comparative example of an adsorption and desorption system 900. The adsorption and desorption system 900 may be part of a carbon capture system, e.g., a direct air carbon capture system. The dynamic adsorption and desorption system 900 includes a track 910 on which a plurality of sorbent carts 90 which hold sorbent are mounted. A desorption station 920 and adsorption stations 930, which are stationary, are positioned at different locations on the track 910. The track 910 moves the sorbent carts 90 between the desorption station 920 and the adsorption stations 930. Adsorption of an input gas or input gases may be performed by the sorbent in the sorbent carts 90 at the adsorption stations 930, and desorption of the sorbent in the sorbent carts 90 may be performed at the desorption station 920.

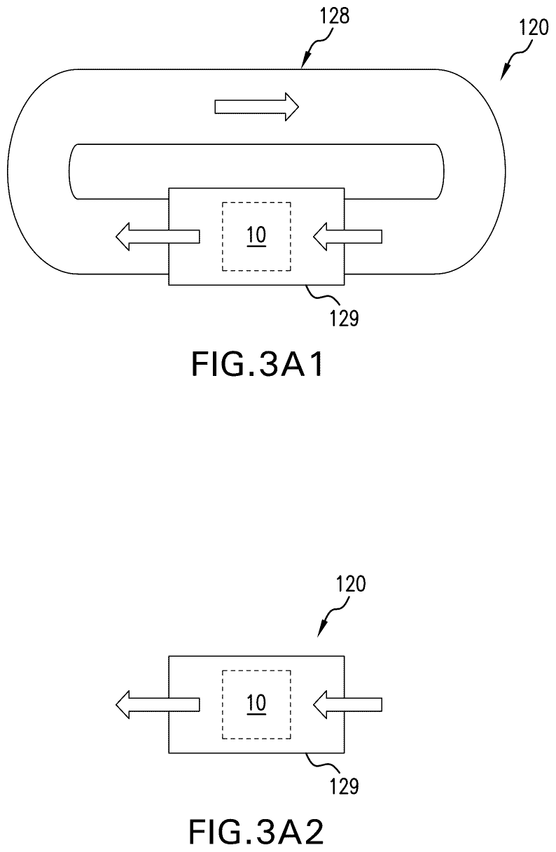

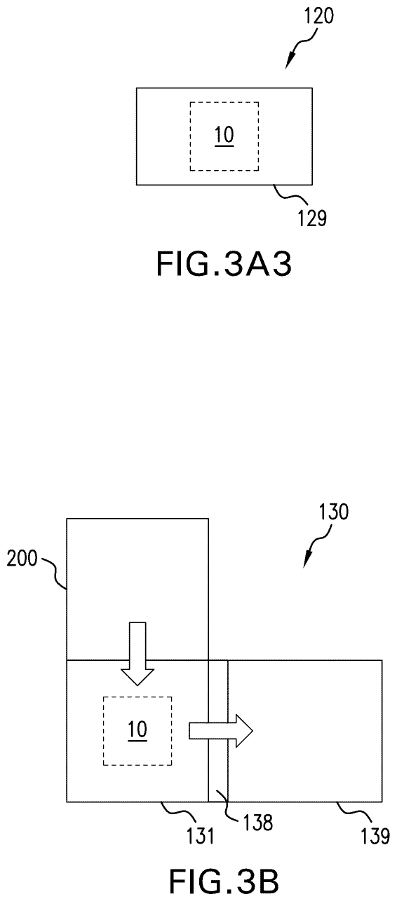

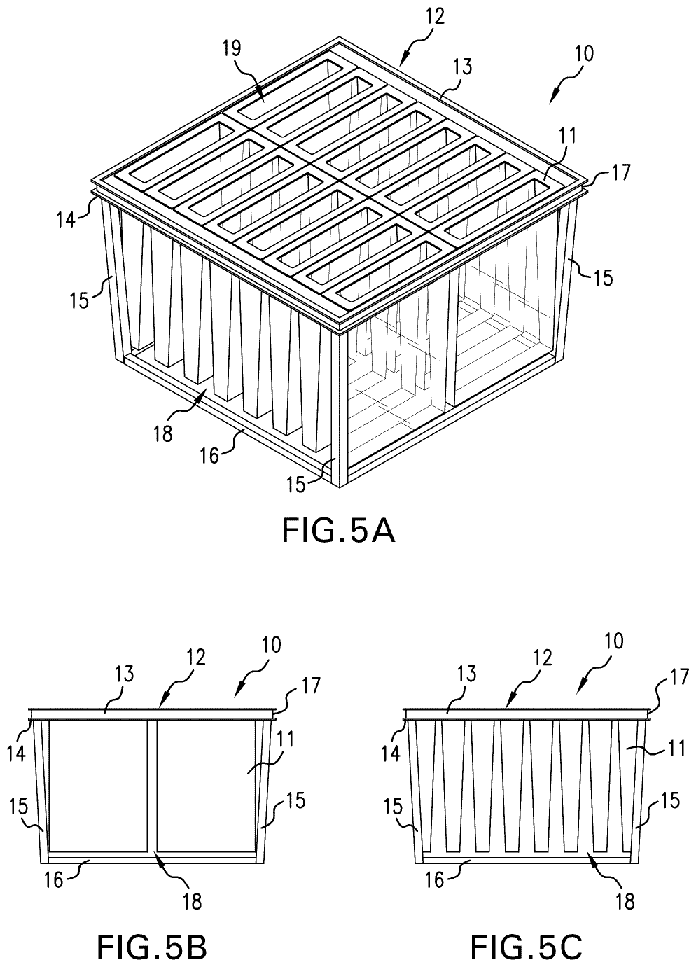

FIG. 2 shows an adsorption and desorption system 100 according to one or more embodiments. The adsorption and desorption system 100 includes desorption stations 120 and adsorption stations 130. FIGS. 3A1, 3A2, and 3A3 show non-limiting examples of a desorption station 120, and FIG. 3B shows a non-limiting example of an adsorption station 130. A sorbent cart 10 may be disposed in each of the desorption stations 120 and adsorption stations 130. Each of the sorbent carts 10 may include sorbent 19 (See FIG. 5A). The desorption stations 120 and the adsorption stations 130 may be independent from each other. That is, the desorption stations 120 and the adsorption stations 130 may not be connected by a track, such that sorbent carts 10 may be moved into and out of each of the desorption stations 120 and the adsorption stations 130 independent of the other desorption stations 120 and adsorption stations 130. Relative positions of the desorption stations 120 and the adsorption stations 130 are not dictated by process sequence or timing. Thus, positions of the desorption stations 120 and the adsorption stations 130 may selected to maximize efficiency of desorption and/or adsorption. For example, the desorption stations 120 and the adsorption stations 130 may be grouped by process type as shown in FIG. 2. Alternatively, positions of the desorption stations 120 and the adsorption stations 130 may be mixed. The sorbent carts 10 may be transported independently of each other. The adsorption and desorption system 100 may allow adsorption to be performed at the adsorption station 130 via the sorbent carts 10 for a first period of time, and for desorption to be performed at the desorption station 120 on the sorbent carts 10 for a second period of time, with the first period of time differing from the second period of time. The adsorption and desorption system 100 may allow adsorption to be performed at one adsorption station 130 via the sorbent carts 10 for a third period of time, and for adsorption to be performed at another adsorption station 130 via the sorbent carts 10 for a fourth period of time, with the third period of time differing from the fourth period of time. The adsorption and desorption system 100 may allow desorption to be performed at one desorption station 120 on the sorbent carts 10 for a fifth period of time, and for desorption to be performed at another desorption station 120 on the sorbent carts 10 for a sixth period of time, with the fifth period of time differing from the sixth period of time.

Adsorption may be performed at the adsorption stations 130 and desorption may be performed at the desorption stations 120. That is, at the adsorption stations 130, sorbent 19 in the sorbent carts 10 adsorbs gas(es), vapor(s), or a mixture thereof from an input gas. The input gas input gas may be atmospheric gas or flue gas from a manufacturing system or a chemical system. For example, as shown in FIG. 3B, an adsorption chamber 131 of the adsorption station 130 may have a sorbent cart 10 therein and may receive the input gas from an input gas source 200, adsorb gas(es), vapor(s), or a mixture thereof from the input gas, and the gas exiting the adsorption chamber 131 may flow to a gas outlet 139. A blower 138 may be disposed upstream of the gas outlet 139 to generate and/or increase flow of the gas. The blower 138 may be disposed at other locations within the adsorption system 130 for generating and/or increasing flow of the gas. At the desorption stations 120, the gas(es), the vapor(s), or the mixture thereof adsorbed at the adsorption stations 130 is desorbed from the sorbent 19 in the sorbent carts 10. For example, as shown in FIGS. 3A1, 3A2, and 3A3, a desorption chamber 129 of the desorption station 120 may have a sorbent cart 10 therein may desorb the gas(es), the vapor(s), or the mixture thereof adsorbed at the adsorption stations 130 from the sorbent 19 in the sorbent cart 10. In the non-limiting example shown in FIG. 3A1, a heated gas or vapor may be passed through a desorption loop 128 into the desorption chamber 129 to release the gas(es), the vapor(s), or the mixture thereof from the sorbent 19 in the sorbent cart 10. In the non-limiting example shown in FIG. 3A2, a heated gas or vapor, such as steam, may be injected into the desorption chamber 129 to release the gas(es), the vapor(s), or the mixture thereof from the sorbent 19 in the sorbent cart 10. In the non-limiting example shown in FIG. 3A3, the desorption chamber 129 may be heated via, for example, conduction or electromagnetic energy, to release the gas(es), the vapor(s), or the mixture thereof from the sorbent 19 in the sorbent cart 10.

As a non-limiting example, if the adsorption and desorption system 100 is part of a carbon capture system, at the adsorption stations 130, the sorbent 19 in the sorbent carts 10 adsorbs carbon dioxide from the input gas, and at the desorption stations 120, the carbon dioxide is desorbed from the sorbent 19 in the sorbent carts 10. In the non-limiting carbon capture example, the input gas may be atmospheric gas or flue gas from a manufacturing system or a chemical system. However, the input gas may be any gas that includes gas(es), vapor(s), or a mixture thereof that there is a benefit to removing from the input gas. Desorption may be performed by heating the sorbent 19 in the sorbent cart 10 by convection, conduction, induction, and/or electromagnetic energy (e.g., microwave energy) and may include a vacuuming step, and the desorption station 120 may include additional structures as appropriate.

The sorbent carts 10 are examples of sorbent structures. The sorbent carts 10 may be integral structures and/or assemblies. As non-limiting examples, the sorbent carts 10 may be contactor assemblies, sorbent beds, and/or sorbent filters. The sorbent 19 may be disposed within the sorbent carts and/or the sorbent carts 10 may function as a sorbent. According to one or more embodiments, the sorbent structure may be formed of sorbent 19 as a self-supporting structure, may be formed as a monolithic sorbent, or may be a structure on which the sorbent 19 is applied as a coating.

The sorbent carts 90 in the comparative example are moved along a common track 910 such that each of the sorbent carts 90 spend an equal amount of time in the respective desorption stations 920 and adsorption stations 930. In contrast, in the adsorption and desorption system 100, a sorbent cart 10 may be moved into and out of any of the desorption stations 120 and the adsorption stations 130 and may stay in the desorption stations 120 and the adsorption stations 130 as desired, e.g., for an optimal amount of time.

Furthermore, in the comparative example, the order in which the sorbent carts 90 are cycled through the desorption station 920 and the adsorption stations 930 are limited by the structure and the locations of the track 910 and the desorption station 920 and the adsorption stations 930. In contrast, in the adsorption and desorption system 100, a sorbent cart 10 may be moved into and out of any of the desorption stations 120 and the adsorption stations 130 non-sequentially and may stay in the desorption stations 120 and the adsorption stations 130 as desired, e.g., for an optimal amount of time.

In addition to the desorption stations 120 and the adsorption stations 130, specialized process stations may be added to increase efficiency of the adsorption and desorption system 100. For example, the adsorption and desorption system 100 may further include drying station(s) 140 and cooling station(s) 150. A sorbent cart 10 may be disposed in each of the drying station(s) 140 and the cooling station(s) 150. The drying station(s) 140 may dry the sorbent carts 10 and/or the sorbent 19 within the sorbent carts 10. The drying station(s) 140 may employ waste heat from the adsorption and desorption system 100 to dry the sorbent carts 10 and/or the sorbent 19 within the sorbent carts 10. The drying station(s) 140 may include a heater, a blower, a fan, and/or any other structures known in the art for drying. The cooling station(s) 150 may cool the sorbent carts 10 and/or the sorbent 19 within the sorbent carts 10. The cooling station(s) 150 may include a heat exchanger, a blower, a fan, and/or any other structures known in the art for cooling. Furthermore, drying may be performed at the adsorption station 130.

While FIG. 2 shows a non-limiting example of an adsorption and desorption system 100 having two desorption stations 120, six adsorption stations 130, two drying stations 140, and two cooling stations 150, the adsorption and desorption system 100 may have any number of desorption stations 120, adsorption stations 130, drying stations 140, and cooling stations 150. Furthermore, any of the desorption stations 120, adsorption stations 130, drying stations 140, cooling stations 150 may be omitted.

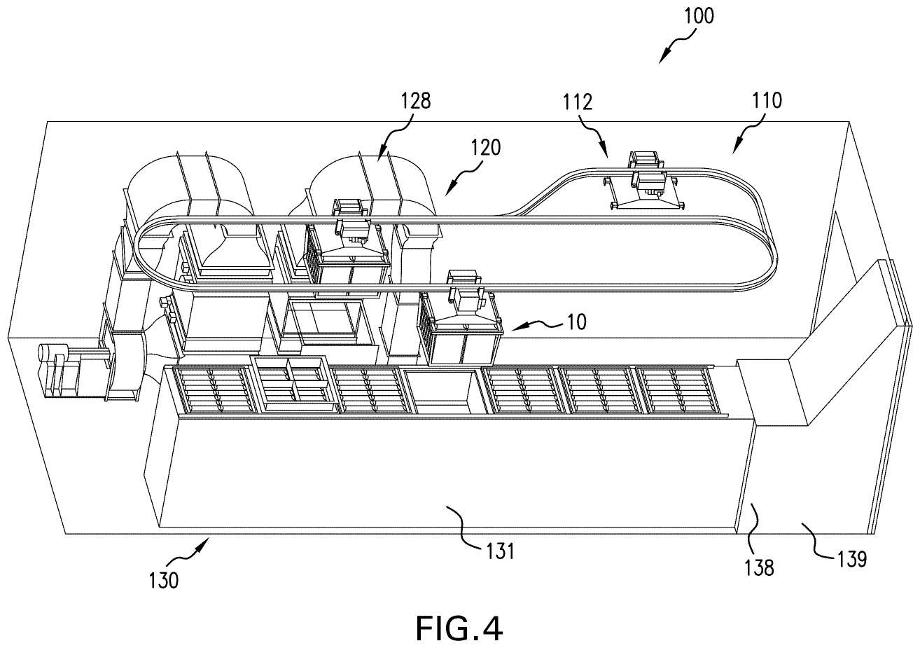

FIG. 4 shows an adsorption and desorption system 100 according to one or more embodiments. The adsorption and desorption system 100 may include a transport system 110 operable to move sorbent carts 10 to and from desorption stations 120 and adsorption stations 130. Although drying stations 140 and cooling stations 150 are not shown in FIG. 4, the adsorption and desorption system 100 may include drying stations 140 and cooling stations 150, and the transport system 110 may be operable to move the sorbent carts 10 to and from the drying stations 140 and/or cooling stations 150 as well. While FIG. 4 shows desorption stations 120 with a flow loop 128 as shown in FIG. 3A1, the desorption stations 120 may be other structures. For example, the desorption stations 120 may be similar to those shown in FIG. 3A2 and/or FIG. 3A3, or other desorption structures known in the art. As shown in FIG. 4, the adsorption stations include adsorption chambers 131, and the gas exiting the adsorption chambers 131 may flow to a gas outlet 139. A blower 138 may be disposed upstream of the gas outlet 139 to generate and/or increase flow of the gas. The blower 138 may be disposed at other locations within the adsorption system 130 for generating and/or increasing flow of the gas.

FIGS. 5A-5C show a sorbent cart 10 according to one or more embodiments. The sorbent cart 10 includes a casing 12 in which a plurality of sorbent modules 11 containing sorbent 19 are disposed. The sorbent 19 may be, for example, metal-organic frameworks, Zeolites, amine-impregnated porous materials, amine-functionalized porous materials, or a combination of one or more of the above. The sorbent 19 may be another sorbent known in the art or a combination of sorbents including those known in the art. The casing 12 may include a first frame 13, a second frame 16, and beams 15 extending from the first frame 13 to the second frame 16. The first frame 13, the second frame 16, and the beams 15 define a space 18 therein into which the sorbent modules 11 extend. The beams 15 may be disposed at the corners of the first frame 13 and the second frame 16. The first frame 13 and the second frame 16 may be parallel to each other. The first frame 13 may be larger than the second frame 16, and the beams 15 may taper from the first frame 13 to the second frame 16 such that the beams 15 extend at an angle with respect to a direction perpendicular to the first frame 13 and the second frame 16. As such, the casing 12 has an outer surface that tapers from the first frame 13 to the second frame 16, which may be an insertion direction of the sorbent cart 10 into the desorption station 120 and/or the adsorption station 130. Additionally or alternatively to the tapered outer surface of the casing 12, the casing 12 may include a guide structure.

The sorbent modules 11 may be supported on the casing 12 via the first frame 13. The first frame 13 may include a center cross-beam (not shown) extending across a central portion thereof to support the sorbent modules 11. The first frame 13 may include an engagement groove 17 that is configured to engage with a sorbent cart carrier 112 of the transport system 110. The first frame 13 may include a sealing surface 14 that is configured to interface with sealing surfaces of the desorption stations 120 and the adsorption stations 130. The sealing surface 14 may be a surface of the first frame 13 facing the second frame 16.

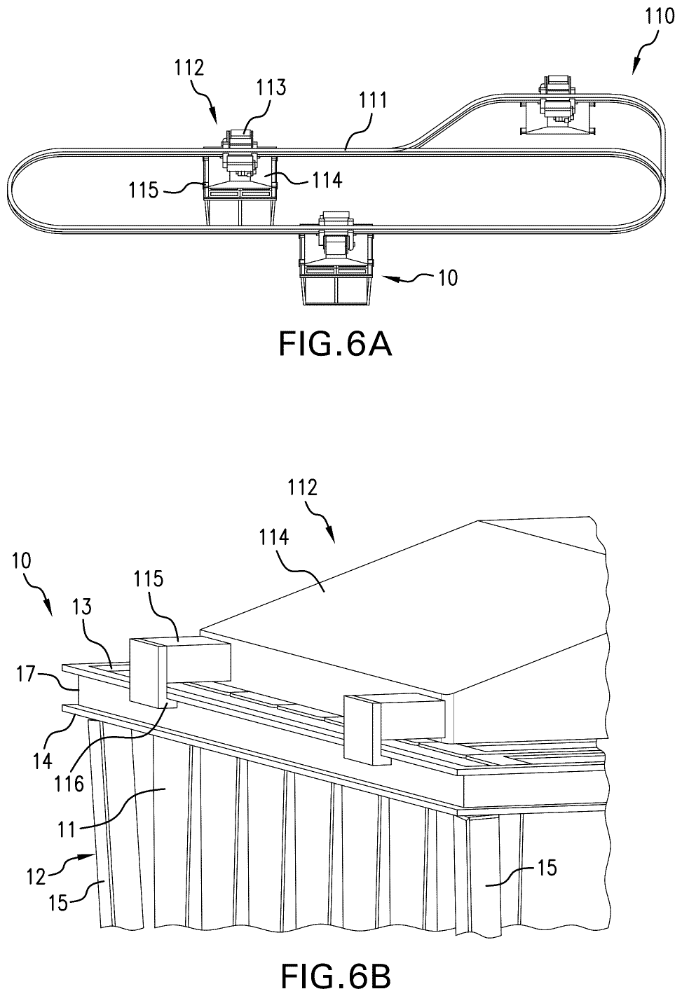

FIGS. 6A and 6B show a transport system 110 according to one or more embodiments. The transport system 110 may include a rail 111 on which a plurality of sorbent cart carriers 112 are disposed. While FIGS. 4 and 6A show three sorbent cart carriers 112, the present disclosure is not limited thereto, and any number of sorbent cart carriers 112 may be disposed on the rail 111. Further, the rail 111 is not limited to any specific shape. The rail 111 may be shaped so as to have a portion thereof align with one or more of the desorption stations 120, adsorption stations 130, drying stations 140, and the cooling stations 150. Further, the rail 111 may be shaped so as to have a portion thereof align with each of the desorption stations 120, adsorption stations 130, drying stations 140, and the cooling stations 150.

The rail 111 may be stationary. Each of the sorbent cart carriers 112 may include a rail engagement portion 113 mounted on a carrier body 114. The rail engagement portion 113 may engage with the rail 111. The rail engagement portion 113 may include a motor, a gear system, rollers, and/or other mechanisms that allow the rail engagement portion 113 to move the sorbent cart carriers 112 with respect to the rail 111. Alternatively, the rail 111 may be a movable. Each of the sorbent cart carriers 112 may be fixed on the rail 111 such that sorbent cart carriers 112 are moved by the movement of the rail 111. For example, the sorbent cart carriers 112 may clamp onto the rail 111. The sorbent cart carriers 112 may include sorbent cart engagement structures 115 that extend from the carrier body 114. The sorbent cart engagement structures 115 may include hooks 116 configured to engage with the engagement grooves 17 of the sorbent carts 10 to allow the sorbent cart carriers 112 to carry the sorbent carts 10. The hooks 116 may be extendable to engage and disengage from the engagement grooves 17. Alternatively, the sorbent cart engagement structures 115 may engage with the sorbent cart 10 via other methods and structures known in the art to allow the sorbent cart carriers 112 to carry the sorbent carts 10.

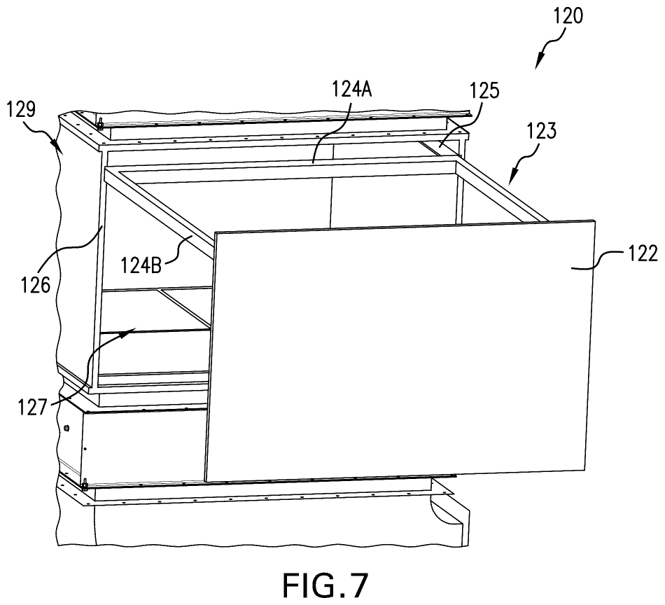

FIG. 7 shows a desorption chamber 129 of a desorption station 120 according to one or more embodiments. The desorption chamber 129 defines a desorption enclosure 127. An access door 122 may be disposed over an opening of the desorption chamber 129 to enclose the desorption enclosure 127. The access door 122 may be supported on the desorption chamber 129 via a door frame 123 that slidingly engages with guide grooves 125 on inner surfaces of the desorption chamber 129 such that the door frame 123 may slide in and out of the desorption enclosure 127. The door frame 123 may be configured to receive the sorbent cart 10. The door frame 123 may be sized to correspond to a portion of the beams 15 of the casing 12 adjacent to the first frame 13 such that, when the sorbent cart 10 is inserted into the door frame 123, the first frame 13 of the sorbent cart 10 is supported on the door frame 123. The door frame 123 may include a first sealing surface 124A that interfaces with the scaling surface 14 of the sorbent cart 10 to form a seal therebetween. A sealing element may be disposed on the sealing surface 14 and/or the first sealing surface 124A to facilitate forming of the seal therebetween. The door frame 123 may further include a sliding seals 124B on the surfaces of the door frame 123 that engage with the guide grooves 125. The desorption chamber 129 may include a second sealing surface 126 that interfaces with the access door 122 to form a seal therebetween. Sealing elements may be disposed on the second sealing surface 126 and/or the access door 122 to facilitate forming of the seal therebetween when the access door 122 is in a close position. Alternatively, the access door 122 may be swingably supported on the desorption chamber 129 via a hinge.

When the access door is in an open position shown in FIG. 7, the sorbent cart 10 may be inserted into the door frame 123 via the sorbent cart carrier 112. For example, the hooks 116 of the sorbent cart carrier 112 may disengage from the engagement grooves 17 of the first frame 13 of the sorbent cart 10 to drop the sorbent cart 10 into the door frame 123. As the second frame 16 of the sorbent cart 10 is smaller than the first frame 13, the second frame 16 casily slots into the door frame 123, and the tapered beams 15 of the sorbent cart 10 may guide the sorbent cart 10 into the door frame 123. Once the sorbent cart 10 is fully inserted into the door frame 123, the door frame 123 may be guided into the desorption chamber 129 via the guide grooves 125 to close the access door 122 and seal the sorbent cart 10 within the desorption enclosure 127. The desorption station 120 performs desorption of the sorbent 19 within the sorbent cart 10 within the sealed desorption enclosure 127.

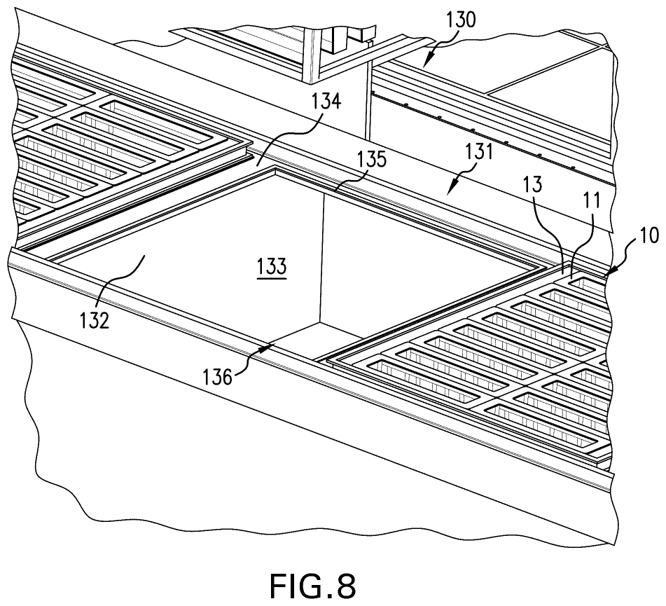

FIG. 8 shows an adsorption chamber 131 of an adsorption station 130 according to one or more embodiments. The adsorption chamber 131 may include inner walls 132 that define an adsorption space 133 therein and an opening 136 providing access to the adsorption space 133 and configured to receive the sorbent cart 10. The opening 136 may be sized to correspond to a portion of the beams 15 of the casing 12 adjacent to the first frame 13 such that, when the sorbent cart 10 is inserted into the opening 136, the first frame 13 of the sorbent cart 10 is supported on a support surface 134 of the adsorption chamber adjacent the opening 136. The support surface 134 may include a sealing lip 135 that interfaces with the sealing surface 14 of the sorbent cart 10 to form a seal therebetween. The sealing lip 135 may be formed of an elastic material to facilitate formation of the seal between the support surface 134 of the adsorption chamber 131 and the sealing surface 14 of the sorbent cart 10.

As the second frame 16 of the sorbent cart 10 is smaller than the first frame 13, the second frame 16 easily slots into the opening 136, and the beams 15 of the sorbent cart 10, which may be tapered, guides the sorbent cart 10 into the adsorption space 133. While the drawings show the inner walls 132 being vertical, according to one or more embodiments, the inner walls 132 may also be tapered to correspond to the shape of the beams 15 to facilitate guiding the sorbent cart 10 into the adsorption space 133. Once the sorbent cart 10 is fully inserted into the adsorption space 133, the adsorption station 130 performs adsorption of gases flowing through the sorbent 19 within the sorbent cart 10. For example, the adsorption chamber 131 may intake atmospheric gas into the sorbent cart 10 and through the sorbent 19 therein to adsorb gas(es), vapor(s), or a mixture thereof from the atmospheric gas which is then exhausted through the gas outlet 139. According to one or more embodiments, the gases may flow vertically through the adsorption space 133.

The adsorption station 130 may be oriented as shown in FIGS. 4 and 8, which allows the sealing between the sealing surface 14 of the sorbent cart 10 and the sealing lip 135 of the adsorption chamber 131 to be weight set. Such a structure may allow moving seals, doors, and/or latches to be omitted. Furthermore, the sorbent cart 10 may be guided into the adsorption space 133 via gravity.

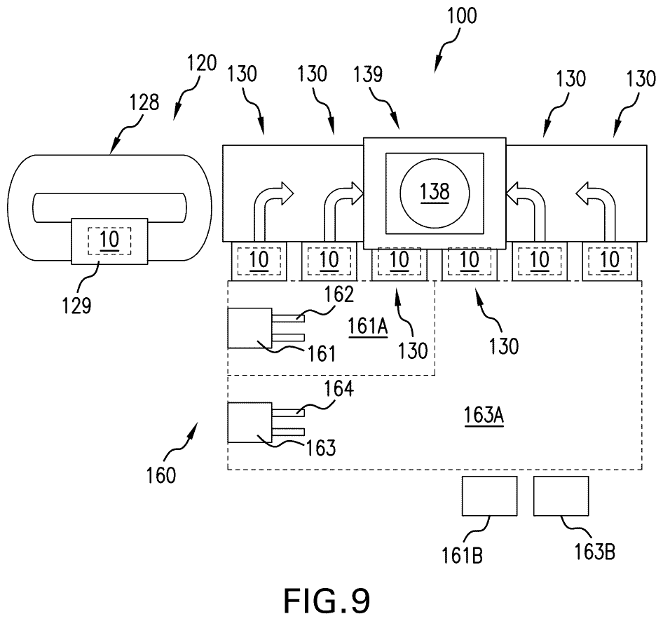

FIG. 9 shows an adsorption and desorption system 100 according to one or more embodiments. The adsorption and desorption system 100 includes a desorption station 120 and a plurality of adsorption stations 130. While FIG. 9 shows one desorption station 120 and six adsorption stations, the present disclosure is not limited thereto, and the adsorption and desorption system 100 may include any number of desorption stations 120 and adsorption stations 130, as well as drying stations 140 and cooling stations 150 (see FIG. 2). The adsorption and desorption system 100 includes a transport system 160 with first and second vehicles 161, 163 configured to move the sorbent carts 10 between desorption stations 120, adsorption stations 130, drying stations 140, and cooling stations 150 (see FIG. 2). The first and second vehicles 161, 163 may be autonomous guided forklifts, and may include fork structures 162, 164. The first vehicle 161 may move within a first area 161A to move the sorbent carts 10 to and from the adsorption stations 130 in and/or adjacent to the first area 161A, and the second vehicle 163 may move within a second area 163A to move the sorbent carts 10 to and from the adsorption stations 130 in and/or adjacent to the second area 163A. The adsorption and desorption system 100 may further include charging stations 161B, 163B for charging the first and second vehicles 161, 163. While first and second vehicles 161, 163, first and second areas 161A, 163A, and two charging stations 161B, 163B are shown in FIG. 9, the present disclosure is not limited thereto, and any number of vehicles, areas, and charging stations may be employed. While FIG. 9 shows desorption stations 120 with a flow loop 128 as shown in FIG. 3A1, the desorption stations 120 may be other structures. For example, the desorption stations 120 may be similar to those shown in FIG. 3A2 and/or FIG. 3A3, or other desorption structures known in the art.

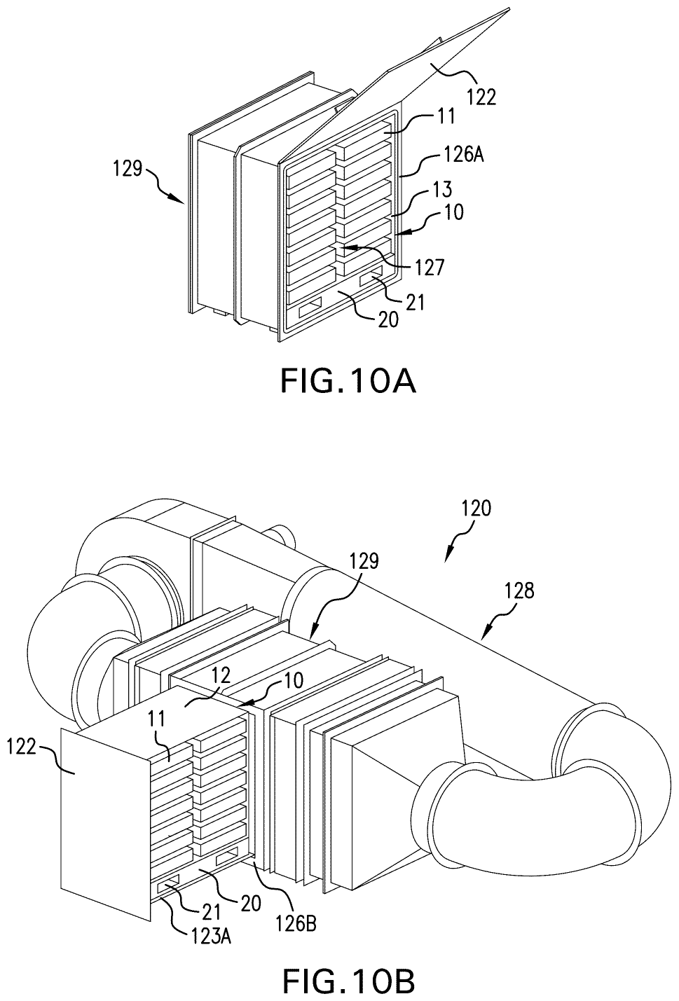

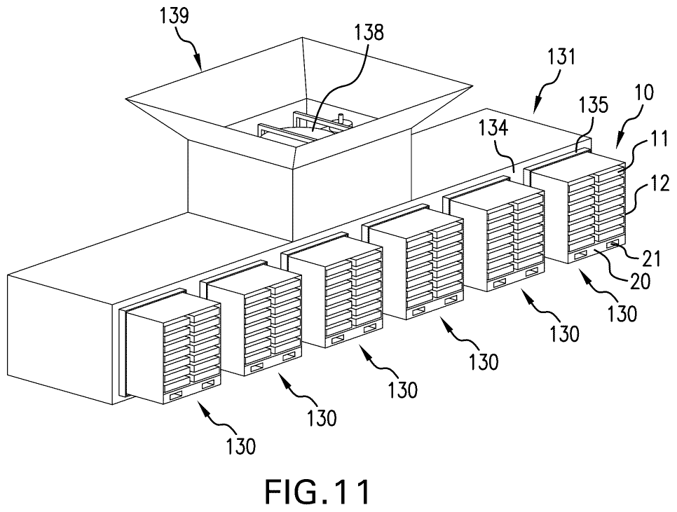

FIG. 10A shows a desorption chamber 129 of a desorption station 120 according to one or more embodiments, FIG. 10B shows a desorption station 120 according to one or more embodiments, and FIG. 11 shows adsorption stations 130 according to one or more embodiments.

While the sorbent cart 10 shown in FIGS. 10A-11 is similar to that shown in FIGS. 5A-5C, the casing 12 may be structured differently. The casing 12 may include a support structure 20 that includes engagement apertures 21 configured to engage with the fork structures 162, 164 of the first and second vehicles 161, 163. That is, the first vehicle 161 and/or the second vehicle 163 may be guided to a position in which the fork structures 162, 164 align with the engagement apertures 21, and the fork structure 162, 164 are inserted into the engagement apertures 21 to allow the first vehicle 161 and/or the second vehicle 163 to carry the sorbent carts 10 between desorption stations 120, adsorption stations 130, drying stations 140, and cooling stations 150.

The desorption chamber 129 shown in FIG. 10A may be employed, for example, in a desorption station 120 shown in FIG. 3A3. The desorption chamber 129 shown in FIG. 10A is similar to that shown in FIG. 7 but includes an access door 122 that is swingably attached to the desorption chamber 129 via a hinge, and the sorbent cart 10 may be directly loaded into and extracted out of the desorption chamber 129 via the first vehicle 161 and/or the second vehicle 163 when the access door 122 is open, and the desorption enclosure 127 may be sealed via a sealing surface 126A when the access door 122 is closed. A sealing element may be disposed on the sealing surface 126A and/or the access door 122 to facilitate forming the seal therebetween.

The desorption station 120 shown in FIG. 10B is similar to that shown in FIGS. 3A1 and 4 but includes an access door 122 that has a support floor 123A that supports the sorbent cart 10 thereon and that slides in and out of the desorption chamber 129. When the access door 122 and the support floor 123A are in an open position shown in FIG. 10B, the sorbent cart 10 may be loaded onto and removed from the support floor 123A. When the support floor 123A is slid into the desorption chamber 129, the access door 122 abuts a sealing surface 126B of the desorption chamber 129 to seal the sorbent cart 10 within the desorption chamber 129. A sealing element may be disposed on the sealing surface 126B and/or the access door 122 to facilitate forming the seal therebetween.

FIGS. 9 and 11 show adsorption stations 130 according to one or more embodiments. The adsorption stations 130 are similar to that shown in FIGS. 3B, 4, and 8, but includes a blower 138 disposed at or adjacent to the gas outlet 139 to move gases through the sorbent carts 10. It is noted that the desorption stations shown in FIGS. 3B, 4, and 8 may include a blower 138 as well. Furthermore, while the adsorption stations 130 in FIGS. 9 and 11 include sealing lips 135, the sealing lips 135 seal against outer walls of the casing 12 of the sorbent cart 10.

The transport system 110, 160 may be configured to receive a sorbent cart 10, move the sorbent cart 10 to an adsorption station 130, insert the sorbent cart 10 into an adsorption chamber 131 of the adsorption station 130 or couple the sorbent cart 10 to the adsorption chamber 131, and separate the sorbent cart 10 from the transport system 110, 160.

The transport system 110, 160 may be configured to receive a sorbent cart 10, move the sorbent cart 10 to a desorption station 120, insert the sorbent cart 10 into a desorption chamber 129 of the desorption station 120 or couple the sorbent cart 10 to the desorption chamber 129, and separate the sorbent cart 10 from the transport system 110, 160.

The transport system 110, 160 may be configured to receive a sorbent cart 10, move the sorbent cart 10 to a drying station 140 or a cooling station 150, and separate the sorbent cart 10 from the transport system 110, 160.

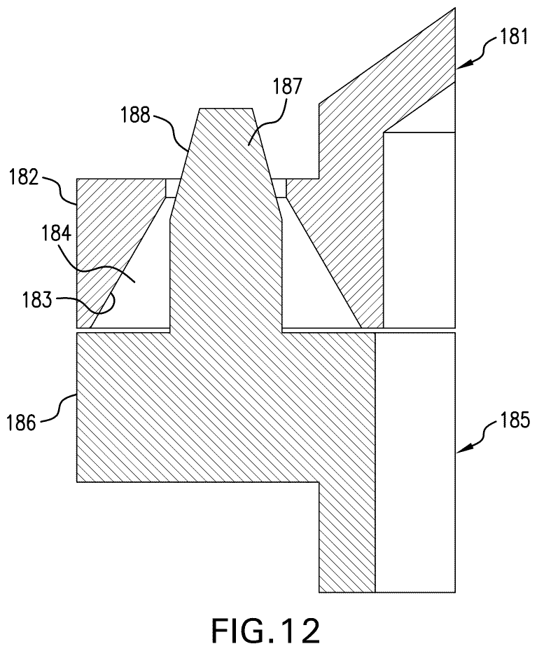

FIG. 12 shows a cone and pin guide assembly 180 according to one or more embodiments. The cone and pin guide assembly 180 includes a first structure 181 and a second structure 185. The first structure 181 may be a sorbent cart 10 and the second structure 185 may be a sorbent cart carrier 112 of a transport system 110, a door frame 123, a support floor 123A, or a desorption chamber 129 of a desorption station 120, or an adsorption chamber 131 of an adsorption station 130. The second structure 185 may be a sorbent cart 10 and the first structure 181 may be a sorbent cart carrier 112 of a transport system 110, a door frame 123, a support floor 123A, or a desorption chamber 129 of a desorption station 120, or an adsorption chamber 131 of an adsorption station 130.

The first structure 181 may include a first flange 182 comprising a cone-shaped aperture 183 which is a through-hole and defines an engagement space 184 therein. The second structure 185 may include a second flange 186 comprising a pin 187 extending therefrom. The pin 187 may include a tapered portion 188. The first structure 181 may be guided onto the second structure 185 by positioning the cone-shaped aperture 183 onto the pin 187, or the second structure 185 may be guided onto the first structure 181 by inserting the pin 187 into the cone-shaped aperture 183. Tapered surfaces of the cone-shaped aperture 183 and the tapered portion 188 help align the first structure 181 and the second structure 185 as they are brought together.

The adsorption and desorption system 100 according to one or more embodiments may be employed in a carbon capture system. The sorbent 19 within the sorbent modules 11 off the sorbent carts 10 may move through a direct air carbon capture process with several stages. The primary stages include an adsorption stage and a desorption stage, although several intermediary conditioning steps may occur between the adsorption and desorption stage. In the adsorption stage, the sorbent cart 10 is moved into an adsorption chamber 131, which may be an array of openings on a common plenum, whereby atmospheric air is moved across the sorbent 19 to capture carbon dioxide from the atmospheric air until a predetermined saturation point of the sorbent 19 is reached. The sorbent cart 10 is then moved from the adsorption stage to the desorption stage.

The desorption stage includes a desorption chamber 129 that may include, for example, a heat exchanger and/or a desorption loop 128, where the carbon dioxide is desorbed from the sorbent. The desorption method may include convection, conduction, induction, and/or electromagnetic energy (e.g., microwave energy) and may include a vacuuming step. Once the desorption stage is complete, the sorbent cart 10 is moved back to the adsorption stage and the process is repeated. During the process, sorbent carts 10 may be replaced to account for attrition during the process.

In addition to the adsorption and desorption stages, intermediary conditioning stages, such as drying and cooling, may be completed in independent process vessels. In this case, the sorbent cart 10 would be moved from the adsorption or desorption stage to the intermediary conditioning stage.

The adsorption and desorption system 100 allows for the adsorption and desorption stages to be independent of each other and, furthermore, allows for additional stages to be added as desired. By uncoupling the different stages, system adaptability may be improved to a variable adsorb/desorb time ratio. As different climate conditions may have different optimal adsorb/desorb time ratios, the adsorb/desorb time ratio may be adjusted for each application to achieve maximum efficiency. Furthermore, the decoupling allows for process flexibility. The variation of relative cycle times with seasonal weather conditions could be exploited to reduce maintenance downtime. Scheduled maintenance can take place when units can be rotated offline without impacting production.

The adsorption and desorption system 100 allows for non-sequential movement of sorbent carts between adsorption stations 130 and desorption stations 120, enabling flexibility to improve efficiency by moving sorbent carts 10 based on process feedback, e.g., carbon dioxide saturation levels.

The adsorption and desorption system 100 may reduce energy requirements, as the sorbent carts 10 are the only mass that undergoes thermal cycling from adsorption to desorption. In conventional systems, sorbent may be housed in a vacuum rated vessel which also undergoes thermal cycling, which may waste energy.

The adsorption and desorption system 100 may reduce cost, as the movement of sorbent carts 10 reduces the required number of desorption stations 120 arranged for the desorption process. The desorption process may involve heating, pressurization, vacuuming, and isolation from ambient conditions to release and capture gas(es), vapor(s), or a mixture thereof (e.g., carbon dioxide) at high purity levels. Thus, desorption stations 120 are often more costly than the comparatively simple adsorption stations 130. By reducing a number of the desorption stations 120 within the adsorption and desorption system 100, cost of the adsorption and desorption system 100 may be reduced.

The adsorption and desorption system 100 does not require adsorption stations 130 and desorption stations 120 to be adjacent or arranged in groupings dictated by cycle time ratios. Thus, the adsorption and desorption system 100 may allow desorption stations 120 to be grouped together and near shared auxiliary equipment, such as vacuum, energy sources, purification, and/or storage equipment (e.g., carbon dioxide tanks).

The adsorption and desorption system 100 may allow for sorbent carts 10 and/or sorbent modules 11 within the sorbent carts 10 to be replaced during service without shutdown of the entire adsorption and desorption system 100.

Because the adsorption and desorption system 100 decouples the adsorption stations 130 and the desorption stations 120, future design optimization of individual components may be implemented without cascading system effects.

The adsorption and desorption system 100 is highly modular and scalable, and different stations may be easily added or removed.

Set forth below are some embodiments of the foregoing disclosure:

Embodiment 1: A system comprising a sorbent structure comprising sorbent, an adsorption station comprising an adsorption chamber configured to receive the sorbent structure and configured to have an input gas pass therethrough to adsorb gas(es), vapor(s), or a mixture thereof via the sorbent, a desorption station comprising a desorption chamber configured to receive the sorbent structure and configured to desorb the gas(es), the vapor(s), or the mixture thereof, and a transport system configured to move the sorbent structure to the adsorption station and insert the sorbent structure into, or couple of the sorbent structure to, the adsorption chamber, and configured to move the sorbent structure to the desorption station and insert the sorbent structure into, or couple the sorbent structure to, the desorption chamber, wherein the sorbent structure separates from the transport system upon inserting the sorbent structure into, or coupling the sorbent structure to, the adsorption chamber or the desorption chamber.

Embodiment 2: The system of any prior embodiment, wherein the sorbent structure comprises a casing with an outer surface that is tapered in an insertion direction of the sorbent structure into the adsorption chamber or the desorption chamber.

Embodiment 3: The system of any prior embodiment, wherein the sorbent structure comprises a casing having a guide structure configured to guide the sorbent structure into the adsorption chamber or the desorption chamber.

Embodiment 4: The system of any prior embodiment, wherein the transport system comprises a rail and a sorbent structure carrier coupled to the rail.

Embodiment 5: The system of any prior embodiment, wherein a first portion of the rail overlaps the adsorption station, and a second portion of the rail overlaps the desorption station.

Embodiment 6: The system of any prior embodiment, wherein the sorbent carrier is movable between the first portion and the second portion.

Embodiment 7: The system of any prior embodiment, wherein the sorbent carrier is configured to grab the sorbent structure from the adsorption station when at the first portion and grab the sorbent structure from the desorption station when at the second portion.

Embodiment 8: The system of any prior embodiment, wherein the sorbent carrier comprises a hook that is configured to engage with an engagement groove on a casing of the sorbent structure.

Embodiment 9: The system of any prior embodiment, wherein the transport system comprises a vehicle configured to move the sorbent structure to the adsorption station and the desorption station.

Embodiment 10: The system of any prior embodiment, wherein the vehicle is an autonomously guided forklift composing a fork structure.

Embodiment 11: The system of any prior embodiment, wherein the sorbent structure comprises apertures configured to engage with the fork structure.

Embodiment 12: The system of any prior embodiment, wherein the sorbent structure comprises a casing with a sealing surface that interfaces with a support surface of the adsorption chamber that supports the sorbent structure to form a seal therebetween.

Embodiment 13: The system of any prior embodiment, wherein a sealing lip is formed on the support surface to facilitate the seal between the sealing surface and the support surface.

Embodiment 14: The system of any prior embodiment, further comprising a drying station for drying the sorbent, the transport system configured to move the sorbent structure to and from the drying station.

Embodiment 15: The system of any prior embodiment, further comprising a cooling station for cooling the sorbent, the transport system configured to move the sorbent structure to and from the cooling station.

Embodiment 16: The system of any prior embodiment, the adsorption chamber is configured to receive the sorbent structure and configured to have atmospheric air pass therethrough to adsorb carbon dioxide therefrom via the sorbent.

Embodiment 17: A method, comprising moving, via a transport system, a sorbent structure comprising sorbent to an adsorption station and separating the sorbent structure from the transport system, performing adsorption for a first period of time on an input gas via the sorbent of the sorbent structure to adsorb gas(es), vapor(s), or a mixture thereof from the input gas, receiving the sorbent structure from the adsorption station via the transport system, moving, via the transport system, the sorbent structure to a desorption station and separating the sorbent structure from the transport system, and performing desorption for a second period of time on the sorbent of the sorbent structure to desorb the gas(es), the vapor(s), or the mixture thereof from the sorbent, wherein the first period of time differs from the second period of time.

Embodiment 18: The method of any prior embodiment, further comprising inserting, via the transport system, the sorbent structure into an adsorption chamber of the adsorption station while guiding the sorbent structure into the adsorption chamber via a tapered outer surface of a casing of the sorbent structure or a guide structure on the casing of the sorbent structure.

Embodiment 19: The method of any prior embodiment, further comprising moving, via the transport system, the sorbent structure to a drying station, separating the sorbent structure from the transport system, and drying the sorbent of the sorbent structure at the drying station.

Embodiment 20: The method of any prior embodiment, further comprising moving, via the transport system, the sorbent structure to a cooling station, separating the sorbent structure from the transport system, and cooling the sorbent of the sorbent structure at the cooling station.

Embodiment 21: The system of any prior embodiment, wherein the system is configured to perform adsorption at the adsorption station for a first period of time and to perform desorption at the desorption station for a second period of time different from the first period of time.

Embodiment 22: The system of any prior embodiment, wherein the adsorption station is a first adsorption station, wherein the system comprises a second adsorption station, and wherein the system is configured to perform adsorption at the first adsorption station for a third period of time and to perform adsorption at the second adsorption station for a fourth period of time different from the third period of time.

Embodiment 23: The system of any prior embodiment, wherein the desorption station is a first desorption station, wherein the system comprises a second desorption station, and wherein the system is configured to perform desorption at the first desorption station for a fifth period of time and to perform desorption at the second desorption station for a sixth period of time different from the fifth period of time.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

The teachings of the present disclosure may be used in a variety of well operations. These operations may involve using one or more treatment agents to treat a formation, the fluids resident in a formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A system comprising:
a sorbent structure comprising sorbent;
an adsorption station comprising an adsorption chamber configured to receive the sorbent structure and configured to have an input gas pass therethrough to adsorb gas(es), vapor(s), or a mixture thereof via the sorbent;
a desorption station comprising a desorption chamber configured to receive the sorbent structure and configured to desorb the gas(es), the vapor(s), or the mixture thereof; and
a transport system configured to move the sorbent structure to the adsorption station and insert the sorbent structure into, or couple of the sorbent structure to, the adsorption chamber, and configured to move the sorbent structure to the desorption station and insert the sorbent structure into, or couple the sorbent structure to, the desorption chamber,
wherein the sorbent structure separates from the transport system upon inserting the sorbent structure into, or coupling the sorbent structure to, the adsorption chamber or the desorption chamber.

2. The system of claim 1, wherein the sorbent structure comprises a casing with an outer surface that is tapered in an insertion direction of the sorbent structure into the adsorption chamber or the desorption chamber.

3. The system of claim 1, wherein the sorbent structure comprises a casing having a guide structure configured to guide the sorbent structure into the adsorption chamber or the desorption chamber.

4. The system of claim 1, wherein the transport system comprises a rail and a sorbent structure carrier coupled to the rail.

5. The system of claim 4, wherein a first portion of the rail overlaps the adsorption station, and a second portion of the rail overlaps the desorption station.

6. The system of claim 5, wherein the sorbent carrier is movable between the first portion and the second portion.

7. The system of claim 6, wherein the sorbent carrier is configured to grab the sorbent structure from the adsorption station when at the first portion and grab the sorbent structure from the desorption station when at the second portion.

8. The system of claim 7, wherein the sorbent carrier comprises a hook that is configured to engage with an engagement groove on a casing of the sorbent structure.

9. The system of claim 1, wherein the transport system comprises a vehicle configured to move the sorbent structure to the adsorption station and the desorption station.

10. The system of claim 9, wherein the vehicle is an autonomously guided forklift composing a fork structure.

11. The system of claim 10, wherein the sorbent structure comprises apertures configured to engage with the fork structure.

12. The system of claim 1, wherein the sorbent structure comprises a casing with a sealing surface that interfaces with a support surface of the adsorption chamber that supports the sorbent structure to form a seal therebetween.

13. The system of claim 12, wherein a sealing lip is formed on the support surface to facilitate the seal between the sealing surface and the support surface.

14. The system of claim 1, further comprising a drying station for drying the sorbent, the transport system configured to move the sorbent structure to and from the drying station.

15. The system of claim 1, further comprising a cooling station for cooling the sorbent, the transport system configured to move the sorbent structure to and from the cooling station.

16. The system of claim 1, the adsorption chamber is configured to receive the sorbent structure and configured to have atmospheric air pass therethrough to adsorb carbon dioxide therefrom via the sorbent.

17. A method, comprising:
moving, via a transport system, a sorbent structure comprising sorbent to an adsorption station and separating the sorbent structure from the transport system;
performing adsorption for a first period of time on an input gas via the sorbent of the sorbent structure to adsorb gas(es), vapor(s), or a mixture thereof from the input gas;
receiving the sorbent structure from the adsorption station via the transport system;
moving, via the transport system, the sorbent structure to a desorption station and separating the sorbent structure from the transport system; and
performing desorption for a second period of time on the sorbent of the sorbent structure to desorb the gas(es), the vapor(s), or the mixture thereof from the sorbent,
wherein the first period of time differs from the second period of time.

18. The method of claim 17, further comprising inserting, via the transport system, the sorbent structure into an adsorption chamber of the adsorption station while guiding the sorbent structure into the adsorption chamber via a tapered outer surface of a casing of the sorbent structure or a guide structure on the casing of the sorbent structure.

19. The method of claim 17, further comprising:
moving, via the transport system, the sorbent structure to a drying station,
separating the sorbent structure from the transport system, and
drying the sorbent of the sorbent structure at the drying station.

20. The method of claim 17, further comprising:
moving, via the transport system, the sorbent structure to a cooling station,
separating the sorbent structure from the transport system, and
cooling the sorbent of the sorbent structure at the cooling station.

21. The system of claim 1, wherein the system is configured to perform adsorption at the adsorption station for a first period of time and to perform desorption at the desorption station for a second period of time different from the first period of time.

22. The system of claim 1, wherein the adsorption station is a first adsorption station, wherein the system comprises a second adsorption station, and wherein the system is configured to perform adsorption at the first adsorption station for a third period of time and to perform adsorption at the second adsorption station for a fourth period of time different from the third period of time.

23. The system of claim 1, wherein the desorption station is a first desorption station, wherein the system comprises a second desorption station, and wherein the system is configured to perform desorption at the first desorption station for a fifth period of time and to perform desorption at the second desorption station for a sixth period of time different from the fifth period of time.
